(19) United States
(12) Patent Application Publication
(10) Pub. No.: US 2019/0134711 A1
(43) Pub. Date: May 9, 2019

(54) Method for processing additively manufactured nickel superalloy components with low porosity and high strength

(71) Applicant: Dongsheng Li, FARMINGTON, CT (US)

(72) Inventor: Dongsheng Li, FARMINGTON, CT (US)

(73) Assignee: Dongsheng Li, East Hartford, CT (US)

(21) Appl. No.: 15/804,654

(22) Filed: Nov. 6, 2017

(51) Int. Cl. B22F 3/15; B33Y 70/00; B33Y 10/00; B22F 3/00; B22F 3/105; C22C 19/05

(52) U.S. Cl. CPC B22F 3/15; B33Y 70/00; B33Y 10/00; B22F 2301/15; B22F 3/1055; C22C 19/056; B22F 3/008

(57) ABSTRACT

This invention relates to low porosity and high strength additive manufactured metallic alloy components and a method and technology of producing as such three dimensional parts by post processing for powder based additive manufactured parts. Post processing procedures include but not limited to Hot Isostatic Pressing (HIP), thermal treatment (HT) and surface treatment. HIP processing temperatures were uniquely selected in the range of 980-1100° C. for additive manufactured parts, lower than the traditional HIP temperature used for cast or wrought parts at 1100-1200° C. in IN718 nickel superalloy. Especially this invention refers to high gamma prime precipitation containing Ni based superalloy powder, such as IN718, IN625, and ME16. With HIP temperature in the range of 980-1100° C., additive manufactured part keep δ precipitate structure intact during HIP processing, preventing abnormal grain growth. HIP processing at lower temperature in the range of 980-1100° C. produces components with lower porosity, larger ductility, higher strength and longer life.

### BACKGROUND OF THE INVENTION

### Field of the Invention

The present invention generally relates to a fine grained, low porosity nickel superalloy component manufactured by additive manufacturing (AM) and post processing. Porosity of the post processed nickel superalloy is lower than 0.5% and the pore size is smaller than 5 um. Post processing steps include hot isostatic pressing (HIP), heat treatment (HT) and surface treatment. HIP temperature is controlled between 980-1100° C. HIP temperature in this invention for additively manufacturing components is lower than HIP temperature utilized for traditional casting and wrought Inconel 718 components, 1150-1200° C. Precipitate does not dissolve at this temperature during HIP processing, preventing abnormal grain growth during HIP process. The post processed components possess fine microstructure, low porosity high strength and long life.

### Background

Most nickel superalloys applied in aerospace and nuclear industries are precipitate hardened alloys designed to display exceptionally high yield, tensile and creep-rupture properties at high temperature up to 700° C. Nickel superalloys have many series, including Inconel, ME, Rene alloys, etc. They are hardened by the precipitation of γ′, γ″ or a phases in γ matrix. These nickel superalloys are the workhorse at high temperature, widely used for gas turbine, cryogenic storage tanks, jet engines, pumps, rocket motors, thrust reversers, nuclear fuel element spacers, hot extrusion tooling and other applications requiring oxidation and corrosion resistance as well as strength at elevated temperatures. Their temperature capability are higher than titanium alloys and they also exhibit excellent high temperature corrosion resistance.

Traditional manufacturing of nickel superalloys has been casting and wrought processing for industrial applications. With the development of additive manufacturing (AM), nickel superalloys, including Inconel 718 parts, have been extensively studied to fabricate using different AM methods in the past decade. Powder feed methods, such as direct metal laser sintering (DMLS) and powder bed methods, such as electron beam melting (EBM), commonly leads to columnar-dendritic microstructure in Inconel 718. To break down the columnar structure, complex scanning strategy have been attempted to control texture of additive manufactured components by researchers in Oak Ridge National Laboratory.

To further improve the microstructure and properties of additive manufactured components, post processing is a critical procedure. Traditional post processing steps for nickel superalloy parts include HIP processing, heat treatment and surface treatment. With decades of development, procedure for cast and wrought Inconel 718 has been standardized and normalized. The similar processing conditions have been applied by Deng et. al. in a published work. HIP at 1162° C. and 103 ksi for 4 hours was able to break the columnar-dendritic microstructure but produced large equiaxed grains (ASTM 1 or larger) with poor mechanical properties.

Abnormal grain growth at traditional HIP post processing conditions are detrimental to the static and dynamic mechanical behavior. It is critical to control grain growth during HIP processing while closing the micropores. Our study demonstrated that traditional HIP condition at temperature 1160° C. dissolved partially δ phase in Inconel 718, removed the grain boundary pinners, and induced abnormal grain growth. To improve the mechanical properties, close micropores, and enhance fatigue life, a new post processing condition, HIP temperature, for additive manufactured nickel superalloy are applied in this invention.

### SUMMARY OF THE INVENTION

This section summarizes some aspects of the present invention and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present invention.

According to one aspect of the present invention, the invention is a nickel superalloy component with low porosity, fine grain microstructure fabricated by additive manufacturing and post processing.

According to yet another embodiment, this invention is a method in post processing additively manufactured nickel superalloy part. HIP processing temperature is optimized by microstructure based model to preserve precipitate in nickel superalloys. For Inconel 718, the HIP processing temperature were investigated in the range of 950-1160° C., with pressure in the range of 100-200 MPa. Selected HIP processing temperature for additively manufactured Inconel 718 is chosen between 980-1100° C.

### BRIEF EXPLANATION OF THE DRAWINGS

FIG. 1 shows a process flow of manufacturing of nickel superalloy part by additive manufacturing and following post processing.

FIG. 2 shows a generalized process flow of post processing for additively manufactured metallic alloy parts.

FIG. 3 shows a special process flow of post processing steps for additively manufactured Inconel 718 alloy parts.

FIG. 4 are micrographs of additively manufactured Inconel 718 (a) before post processing, (b) after HIP at 1000° C., (c) after HIP at 1040° C.

FIG. 5 shows pore size distribution of additively manufactured Inconel 718 without HIP and HIP at different temperatures.

FIG. 6 shows stress strain curves of additively manufactured Inconel 718 alloy before post processing at room temperature and high temperature.

FIG. 7 shows stress strain curves of additively manufactured Inconel 718 alloys after heat treatment without HIP.

FIG. 8 shows room temperature stress strain curves of additively manufactured Inconel 718 alloys after HIP at different temperature and following heat treatment.

FIG. 9 shows high temperature stress strain curves of additively manufactured Inconel 718 alloys after HIP at different temperature and following heat treatment.

FIG. 10 shows room temperature (a) yield strength and (b) ultimate tensile strength of additively manufactured Inconel 718 part after HIPped at different temperatures.

FIG. 11 shows high temperature (a) yield strength and (b) ultimate tensile strength of additively manufactured Inconel 718 part after HIPped at different temperatures.

FIG. 12 shows room temperature (a) yield strength and (b) ultimate tensile strength of additively manufactured Inconel 718 part after different combination of post processing steps.

FIG. 13 shows high temperature (a) yield strength and (b) ultimate tensile strength of additively manufactured Inconel 718 part after different combination of post processing steps.

In the following detailed description, reference is made to the accompanying drawings, which form a part hereof, and in which is shown by way of illustration, and not by way of limitation, specific embodiments in which the disclosure may be practiced. It is to be understood that other embodiments may be utilized and that changes may be made without departing from the spirit and scope of the present disclosure.

### DETAILED DESCRIPTION OF EMBODIMENTS

The detailed description of the invention is presented largely in terms of procedures, steps, logic blocks, processing and other symbolic representations that directly or indirectly resemble the manufacturing and processing. These process descriptions and representations are typically used by those skilled in the art to most effectively convey the substance of their work to others skilled in the art.

Aspects of the present disclosure are described herein with reference to flowchart, data flow, equations, and/or block diagrams according to embodiments of the disclosure. It will be understood that each block of the flowchart, data flow, block diagrams, and/or combination of them, can be implemented by fabrication instructions.

According to various aspects of the present disclosure, the manufacturing of low porosity high strength nickel superalloy part is carried out according to one or more approaches set out herein.

Numerous specific details are set forth in order to provide a thorough understanding of the present invention. However, it will become obvious to those skilled in the art that the invention may be practiced without these specific details on additive manufacturing, post processing, HIP and nickel superalloys. In other instances, well known methods, procedures, and components have not been described in detail to avoid unnecessarily obscuring aspects of the present invention.

Reference herein to “one embodiment” or “an embodiment” means that a particular representation, method, definition, feature, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

### DETAILED DESCRIPTION OF THE EMBODIMENTS

The present invention pertains to use a new post processing condition to tailor microstructure and enhance mechanical properties of additively manufactured nickel superalloy part. In other words, the new post processing condition produces low porosity and refined grain microstructure, high strength and long fatigue life.

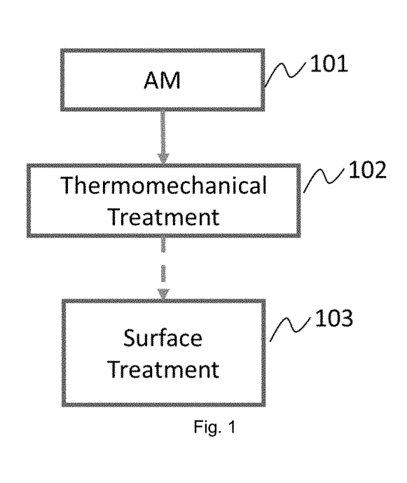

FIG. 1 shows an embodiment of the invention in which how a nickel superalloy part is fabricated. First, the part is additively manufactured in step 101. Additive manufacturing methods applicable to this invention include, but not limited to powder bed fusion process, direct energy deposition process, direct write, materials jetting, extrusion based process, sheet lamination, binder jetting. For nickel superalloy parts, post processing are necessary to improve mechanical performance. Second step is 102, thermomechanical treatment, to enhance properties using thermal and non-thermal techniques. Third step 103 is surface treatment. Step 103 is optional, based on the final request from customers, to improve surface texture, replicate pattern, enhance fatigue life, or for aesthetic purposes.

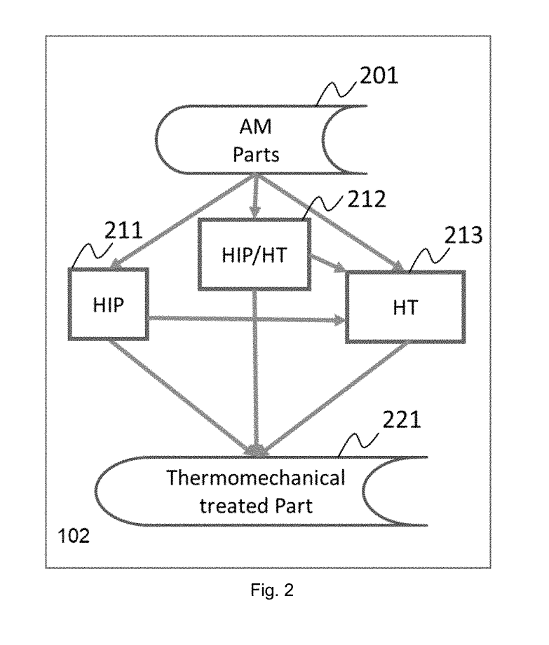

FIG. 2 shows an embodiment of this invention in which the details of step 102 is illustrated. This step 102 starts from additively manufactured part, 201, stops at thermomechanically treated part, 221. Part 221 is ready for the final surface treatment 103. To reach status of part 221 from part 201, there are a combination of thermomechanical treatment procedures to choose from. For part with no need of further heat treatment, part 201 can reach part 221 with only one step of HIP 211. For part with requirement for heat treatment, especially for nickel superalloys, part 201 will reach status 221 through HIP step 211, followed by step 213. Further development in HIP equipment make it possible to combine HIP with heat treatment. Depending on facility and heat treatment step requirement, this combination are possible through one combined step 212, HIP/HT, in one equipment. It is also possible through two steps, with step 212, HIP/HT in one equipment, followed by step 213, heat treatment in another equipment. For some application, for example, static Ti64 parts, there is no need for HIP, one step 213 heat treatment will be sufficient for status 201 to reach status 221.

An example is demonstrated in Inconel 718, a nickel superalloy.

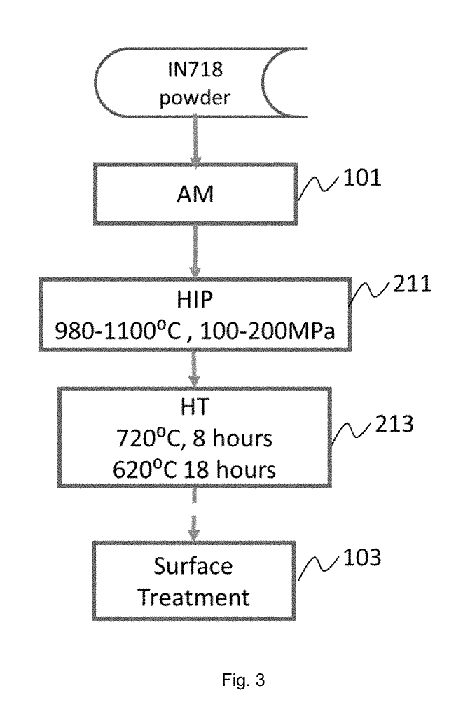

FIG. 3 shows an embodiment of this invention in which this invention is applied in post processing of additive manufactured Inconel 718 alloy parts. Nominal chemical composition of the Inconel 718 powder is listed in Table 1.

TABLE 1
Chemical composition (mass %) of Inconel 718 powder

| Ni | Cr | Fe | Mo | Nb | Co | Mn | Cu | Al | Ti |
|---|---|---|---|---|---|---|---|---|---|
| 53.2 | 18.2 | 16.7 | 3.2 | 5.1 | 0.9 | 0.35 | 0.6 | 0.85 | 0.82 |

First, Inconel 718 powder is fabricated into solid part using additive manufacturing through step 101. Rectangular prisms Inconel 718 prisms with size of 2 cm*2 cm*10 cm was fabricated by laser engineered near shaping machine in helium environment. Laser power, powder feed rate, and other processing parameters were adjusted to optimize the mechanical property and decrease porosity.

Additively manufactured part was first HIP in step 211, then followed by heat treatment in step 213. HIP was carried out for 4 hours under different temperatures in the range of 950-1160° C. and different pressure in the range of 100-200 MPa. Following heat treatment was carried out in an oven, 720° C. for 8 hours and 620° C. for 18 hours. Surface treatment is optional based on the aesthetic and life requirement.

Traditional HIP temperature for Inconel 718 is set up at higher temperature 1150-1200° C. To avoid partial melting/solution of precipitate δ phase in Inconel 718, a lower HIP temperature is chosen in this invention. HIP temperature investigated were 950° C., 1000° C., 1040° C. and 1160° C.

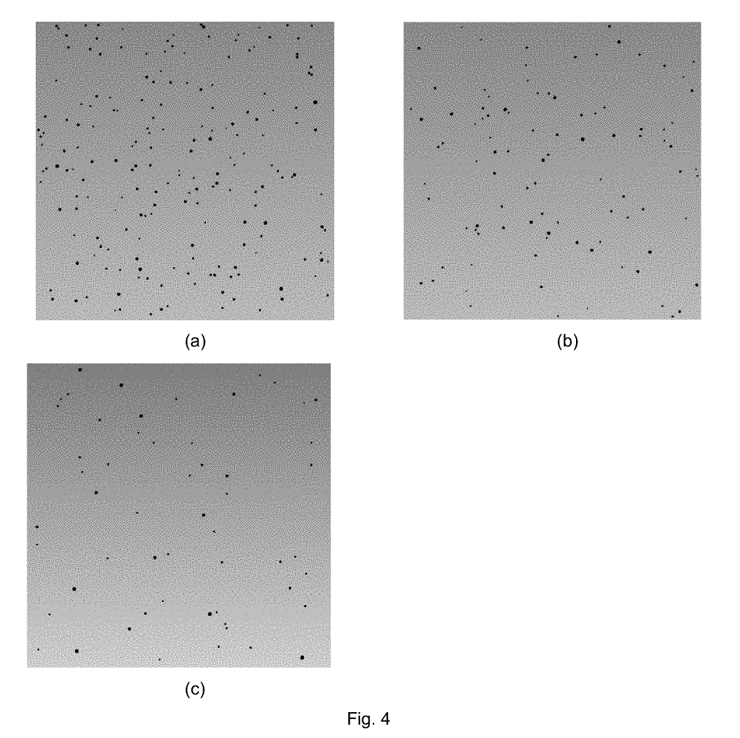

FIG. 4 shows micrographs of cross sectioned Inconel 718 specimen at different processing conditions. FIG. 4(a) is micrograph of additively manufactured Inconel 718 before HIP. Porosity of Inconel 718 immediately after additive manufacturing was 1.0%. FIG. 4(b) is a micrograph of Inconel 718 after HIPped at 1000° C. and heat treatment. Porosity for Inconel 718 HIPped at 1000° C. is decreased to 0.5%. FIG. 4(c) is a micrograph of Inconel 718 after HIPped at 1040° C. and heat treatment. Porosity for Inconel 718 HIPed at 1040° C. is further decreased to 0.3%.

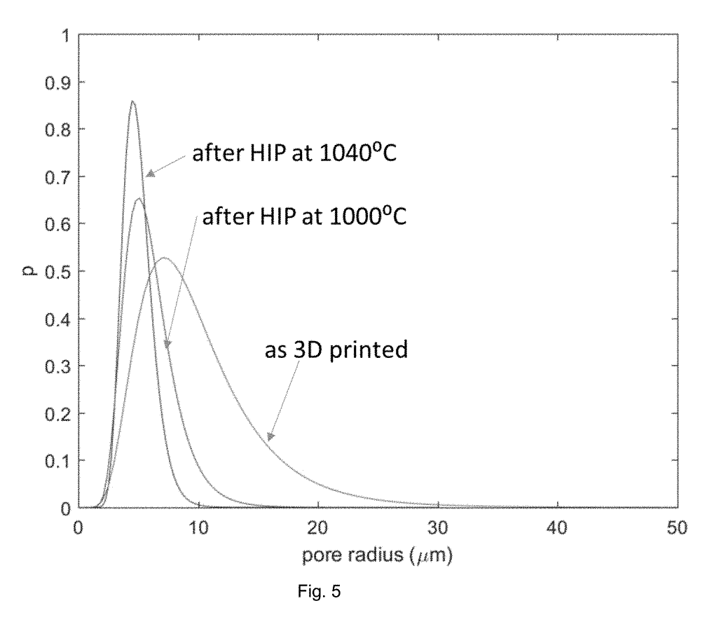

FIG. 5 shows pore size distribution of Inconel 718 specimens shown in FIG. 4. Pore size distribution of Inconel 718 follows lognormal distribution. The average pore size in additive manufactured Inconel 718 without HIP is around 10 μm. The average pore size in additive manufactured Inconel 718 after HIP at 1000° C. is around 7 μm. The average pore size in additive manufactured Inconel 718 after HIP at 1040° C. is around 5 μm.

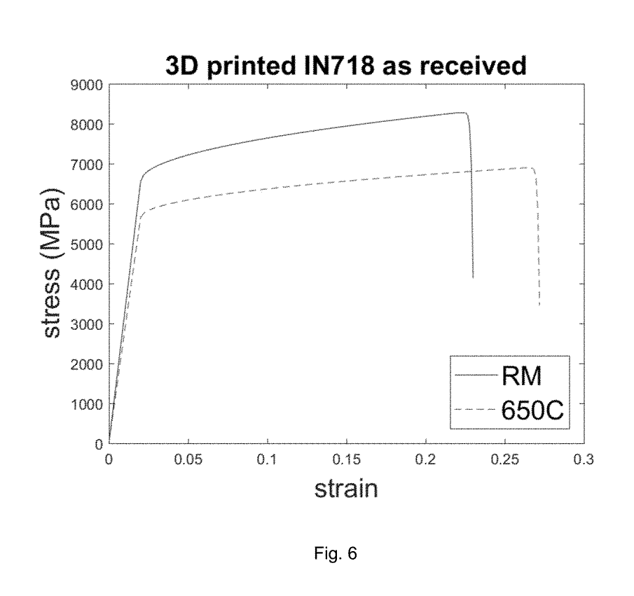

FIG. 6 shows stress strain curves of additively manufactured Inconel 718 before HIP. Ductility is larger than 20% at both room temperature and high temperature 650° C. Ultimate tensile strength is larger than 600 MPa at both room temperature and high temperature 650° C.

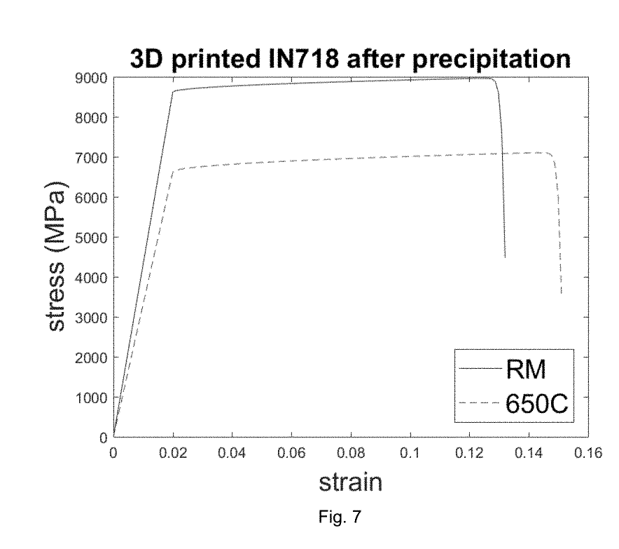

FIG. 7 shows stress strain curves of additively manufactured Inconel 718 after heat treatment without HIP. Yield strength and ultimate tensile strength increased dramatically at both room temperature and high temperature 650° C. Ductility decreased at room temperature and high temperature 650° C., to less than 16%.

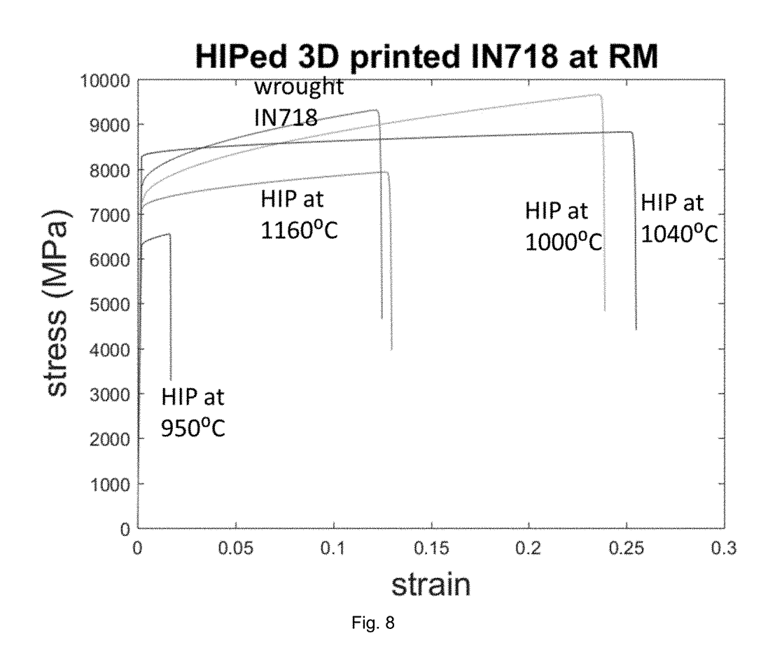

FIG. 8 compares room temperature mechanical deformation behavior of additively manufactured Inconel 718 HIPped at different temperatures, followed by heat treatment. Stress strain curve of wrought Inconel 718 is used as baseline for comparison. HIP at 950° C. shows low ductility, less than 5%. HIP at 1000° C. and 1040° C. both produced large ductility over 20%. HIP at higher temperature 1050° C. decreased ductility to the level of normal wrought Inconel 718.

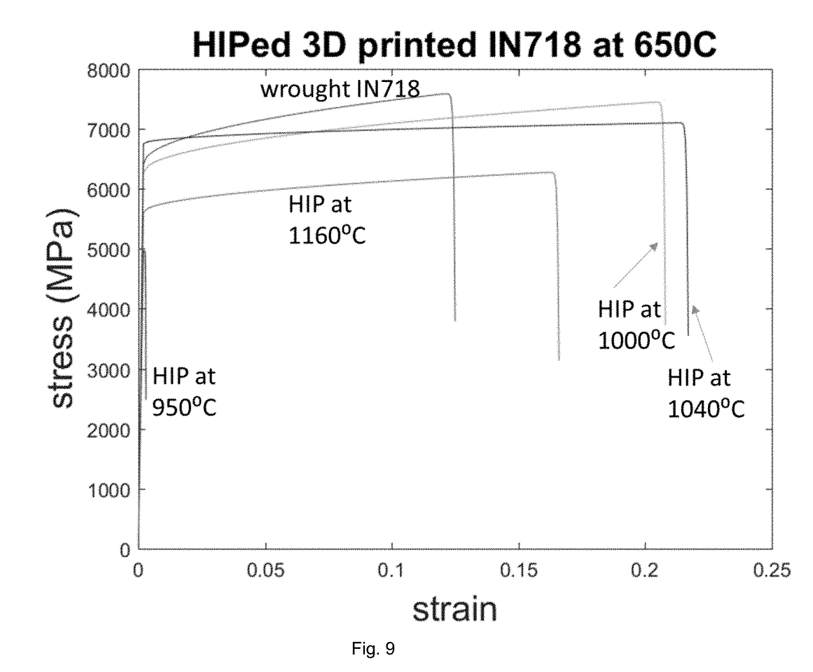

FIG. 9 compares high temperature (650° C.) mechanical deformation behavior of additively manufactured Inconel 718 HIPped at different temperatures, followed by heat treatment. Stress strain curve of wrought Inconel 718 is used as baseline for comparison. It demonstrated similar trend as in FIG. 7. HIP at 950° C. shows low ductility, less than 5%. HIP at 1000° C. and 1040° C. both produced large ductility over 20%. HIP at higher temperature 1050° C. decreased ductility, close to the level of normal wrought Inconel 718.

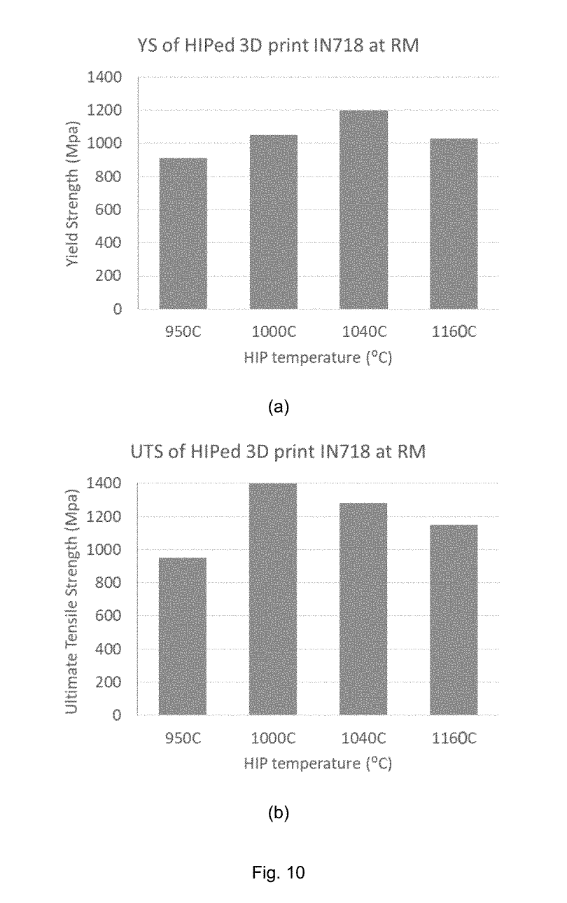

FIG. 10 (a) compares room temperature yield strengths of additively manufactured Inconel 718 HIPped at different temperatures, followed by heat treatment. Yield strengths increased with HIP temperature from 950° C., but decreased when HIP temperature reached 1160° C. Additively manufactured Inconel 718 HIPped at 1040° C. has the highest room temperature yield strength.

FIG. 10 (b) compares room temperature ultimate tensile strengths of additively manufactured Inconel 718 HIPped at different temperatures, followed by heat treatment. Ultimate tensile strengths increased with HIP temperature from 950° C., but decreased when HIP temperature reached 1160° C. Additively manufactured Inconel 718 HIPped at 1000° C. has the highest room temperature ultimate tensile strength.

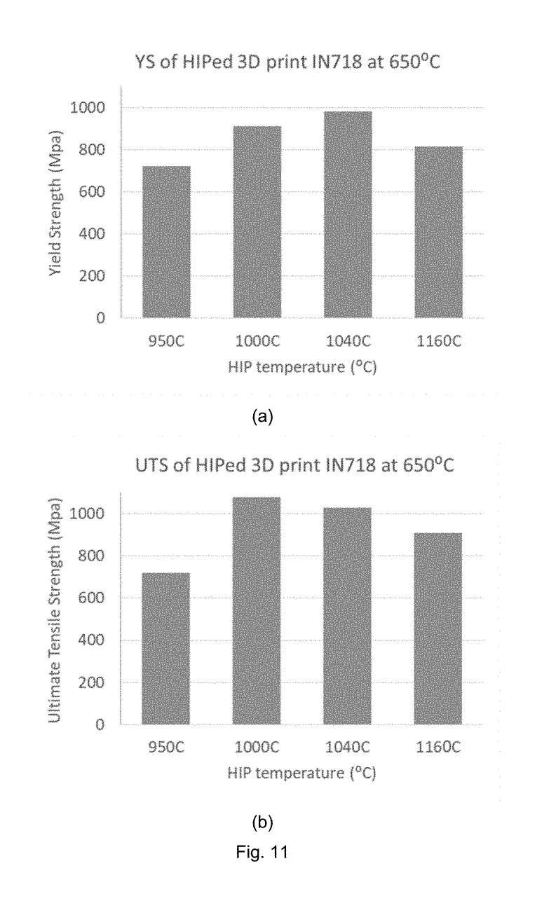

FIG. 11 (a) compares high temperature (650° C.) yield strengths of additively manufactured Inconel 718 HIPped at different temperatures, followed by heat treatment. Yield strengths increased with HIP temperature from 950° C., but decreased when HIP temperature reached 1160° C. Additively manufactured Inconel 718 HIPped at 1040° C. has the highest 650° C. yield strength.

FIG. 11 (b) compares high temperature (650° C.) ultimate tensile strengths of additively manufactured Inconel 718 HIPped at different temperatures, followed by heat treatment. Ultimate tensile strengths increased with HIP temperature from 950° C., but decreased when HIP temperature reached 1160° C. Additively manufactured Inconel 718 HIPped at 1000° C. has the highest 650° C. ultimate tensile strength.

From the point of view of ductility, yield strength and ultimate tensile strength, the optimal HIP temperature for additive manufactured Inconel 718 is selected in the range of 980-1100° C.

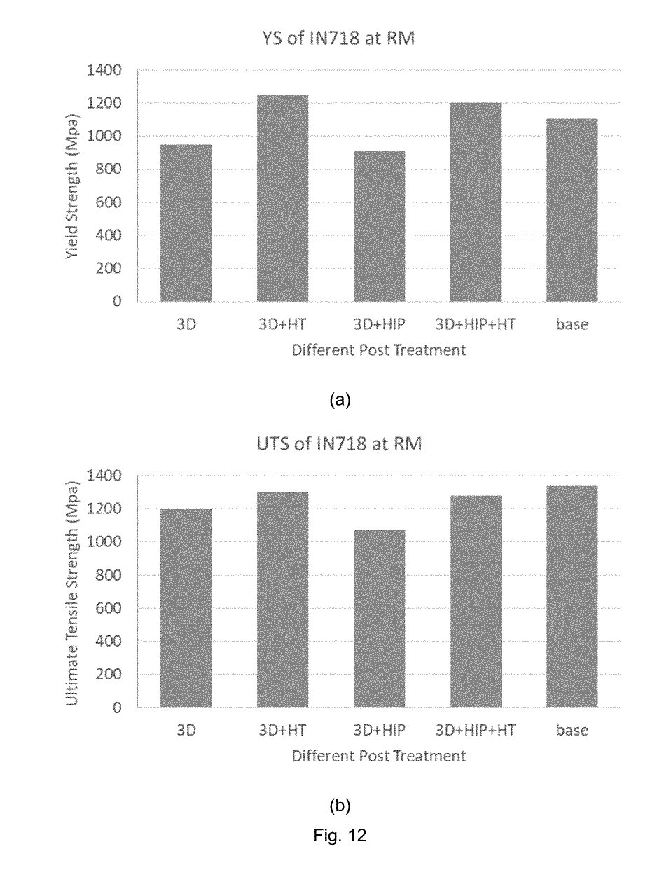

FIG. 12(a) compares room temperature yield strength of additively manufactured Inconel 718 after three different post processing, only HIP without HT, only HT without HIP, and HIP followed by HT. HIP temperature was set up at 1040° C. Baselines of wrought Inconel 718 and additively manufactured Inconel 718 without post processing are used for comparison. Yield strengths of additively manufactured Inconel 718 without post processing and additively manufactured Inconel 718 followed by only HIP are both lower than yield strength of wrought Inconel 718. Yield strengths of additively manufactured Inconel 718 followed by heat treatment and additively manufactured Inconel 718 followed by HIP and heat treatment are both higher than yield strength of wrought Inconel 718. Post processing HIP and heat treatment increased room temperature yield strength and lowered the porosity.

FIG. 12(b) compares room temperature ultimate tensile strength of additively manufactured Inconel 718 after different post processing, only HIP without HT, only HT without HIP, and HIP followed by HT. HIP temperature was set up at 1040° C. Baselines of wrought Inconel 718 and additively manufactured Inconel 718 without post processing are used for comparison. Ultimate tensile strengths of additively manufactured Inconel 718 without post processing and additively manufactured Inconel 718 followed by only HIP are both lower than ultimate tensile strength of wrought Inconel 718. Ultimate tensile strengths of additively manufactured Inconel 718 followed by heat treatment and additively manufactured Inconel 718 followed by HIP and heat treatment are both comparable to ultimate tensile strength of wrought Inconel 718. Post processing HIP and heat treatment increased room temperature ultimate tensile strength and lowered the porosity.

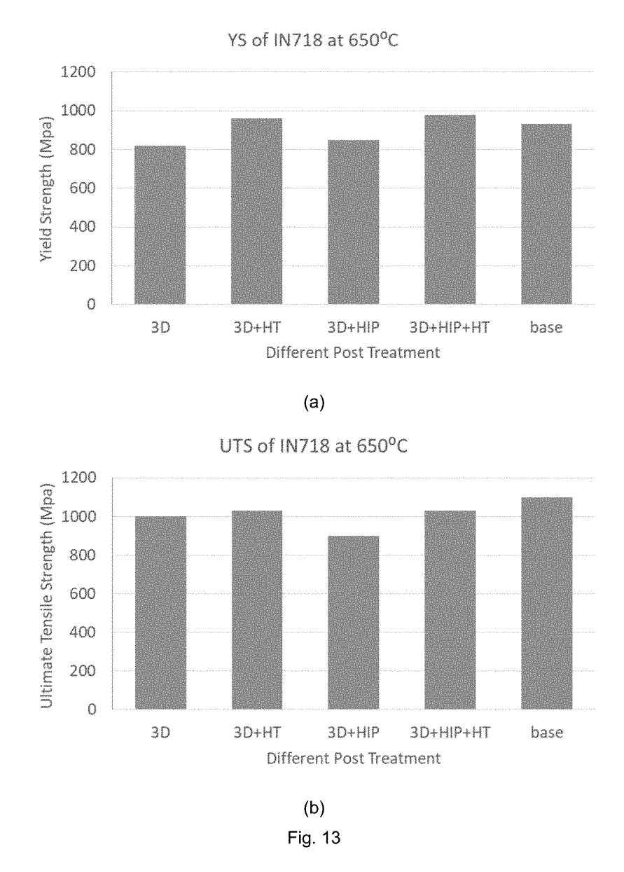

FIG. 13(a) compares high temperature (650° C.) yield strength of additively manufactured Inconel 718 after different post processing, only HIP without HT, only HT without HIP, and HIP followed by HT. HIP temperature was set up at 1040° C. Baselines of wrought Inconel 718 and additively manufactured Inconel 718 without post processing are used for comparison. Yield strengths of additively manufactured Inconel 718 without post processing and additively manufactured Inconel 718 followed by only HIP are both lower than yield strength of wrought Inconel 718. Yield strengths of additively manufactured Inconel 718 followed by heat treatment and additively manufactured Inconel 718 followed by HIP and heat treatment are both higher than yield strength of wrought Inconel 718. Post processing HIP and heat treatment increased 650° C. yield strength and lowered the porosity.

FIG. 13(b) compares high temperature (650° C.) ultimate tensile strength of additively manufactured Inconel 718 after different post processing, only HIP without HT, only HT without HIP, and HIP followed by HT. HIP temperature was set up at 1040° C. Baselines of wrought Inconel 718 and additively manufactured Inconel 718 without post processing are used for comparison. Ultimate tensile strengths of all additively manufactured Inconel 718 specimens without or without post processing are lower than but comparable to ultimate tensile strength of wrought Inconel 718. Compared with additively manufactured component, HIP decreased the ultimate tensile strength. HT increased the ultimate tensile strength.

We claim:

1. A nickel superalloy additively manufactured component with low porosity, long life and high strength.

2. The material as recited in claim 1, wherein the porosity is lower than 0.5%.

3. The material as recited in claim 1, wherein the nickel superalloy includes but not limited to precipitate hardened Inconel alloys, ME alloys and Rene alloys.

4. The material as recited in claim 1, wherein Inconel alloys include but not limited to IN718 and IN625.

5. A method for manufacturing the low porosity high strength additive manufactured nickel superalloy component by additive manufacturing and post processing.

6. The method as recited in claim 5, wherein the additive manufacturing methods include but not limited to powder bed fusion, powder energy deposition and binder jetting.

7. The methods as recited in claim 5, wherein the post processing methods include but not limited to hot isostatic pressing, heat treatment and surface treatment.

8. The methods as recited in claim 7, wherein the hot isostatic pressing temperature for IN718 is in the range of 980-1100° C.

9. The methods as recited in claim 7, wherein the hot isostatic pressing pressure for IN718 is in the range of 100-200 MPa.

10. The methods as recited in claim 7, wherein the hot isostatic pressing time for IN718 is in the range of 1-4 hours.
